(19) United States
(12) Patent Application Publication
(10) Pub. No.: US 2023/0073280 A1
(43) Pub. Date: Mar. 9, 2023

(54) TARGET FOR TRIGGERING NUCLEAR FUSION REACTIONS NON-THERMALLY, SYSTEM AND METHOD FOR PRODUCING FUSION ENERGY

(71) Applicant: Marvel Fusion GmbH, Munich (DE)

(72) Inventors: Georg Korn, Kleinmachnow (DE); Hartmut Ruhl, Kefenrod (DE)

(21) Appl. No.: 17/898,237

(22) Filed: Aug. 29, 2022

(30) Foreign Application Priority Data
Aug. 30, 2021 (EP) 21193867.5
Dec. 2, 2021 (EP) 21211940.8
Feb. 2, 2022 (EP) 22154865.4

(51) Int. Cl. G21B 3/00

(52) U.S. Cl. CPC G21B 3/006

(57) ABSTRACT

A target (10) for triggering nuclear fusion reactions non-thermally includes a plurality of aligned nano-rods (12) of a first nuclear fusion fuel material, and an interspace between the nano-rods filled with a second nuclear fusion fuel material. The first and second nuclear fusion fuel materials are different from each other. In some embodiments, the nuclei of the first nuclear fusion fuel material have a first atomic number and nuclei of the second nuclear fusion fuel material have a second atomic number, wherein the first atomic number is higher than the second atomic number. A system for producing neutronic and aneutronic fusion energy by a neutronic and/or aneutronic nuclear fusion reaction includes a target (10) and a laser device for emitting a laser pulse that can at least partially be absorbed by the target (10).

### BACKGROUND

### Technical Field

The present disclosure relates to a target in the field of triggering non-thermally neutronic and aneutronic nuclear fusion reaction, as well as a corresponding system and method for producing neutronic and aneutronic fusion energy by a neutronic and/or aneutronic nuclear fusion reaction.

### Description of the Related Art

Fusion energy relies on the merging of light nuclei to form a heavier nucleus, where the reduced mass of the reaction product is transformed to energy according to E=mc². Among the reactions known today, combinations of the isotopes Deuterium and Tritium, also called D-T or DT, offer the best cross section and the lowest ignition temperature. The nuclear fusion reaction of DT results in a massive production of fast neutrons around 14.1 MeV which are then used for energy production by transforming their kinetic energy via absorption into heat in a surrounding blanket.

Further known is a lean neutronic (aneutronic) fusion reaction of Boron-11 and a proton, also called PB-11, p-B, pB¹¹ or pB, which results in charged reaction products, following the equation p+B^{11→}3α+8.9 MeV. A disadvantage of this lean neutronic fusion reaction is that it requires far higher temperatures of around 570 keV to reach energy producing fusion burn. Direct ignition of pB was considered unlikely using conventional thermonuclear approaches.

One of the general concepts to ignite nuclear fusion for using its energy in electric power generation is Inertial Fusion Energy, abbreviated IFE, to which the present disclosure relates.

In Inertial Fusion Energy concepts, the fusion fuel is compressed to high densities and maintained at fusion densities and temperatures by its own inertia. The most common approach to IFE is based on lasers as driver technology for igniting the fuel.

Laser driven IFE offers the prospect of a comparably versatile system, where modifications on one part of the system do not always affect other parts. This allows decoupling of the design of the fusion reactor from the driving laser system. Today, generally two types of fusion strategies are known, namely, Hot Spot and Fast Ignition. The present disclosure is a novel non-thermal approach to laser-driven IFE.

Fast Ignition strategies have been researched extensively, particularly at the National Ignition Facility, Lawrence Livermore National Laboratory, Livermore, Calif., USA, also called NIF, and the LFEX facility in Osaka, Japan. This approach uses a combination of two laser pulses. First, a long laser pulse causes an implosion and compression of the fuel because compressing the fuel reduces the amount of heat needed. Next, a shorter, fast laser pulse induces ignition. This reduces the amount of energy delivered in each of the two steps. The longer pulse can be “shaped” to be more efficient, reducing the overall energy needed and thereby in requiring smaller lasers.

M. Tabak, et al., Phys. Plasmas 1, 1626 (1994) proposes Fast Ignition as an approach to increase the gain, reduce the drive energy, and relax the symmetry requirements for compression. The idea is to first pre-compress the cold fuel to an intermediate density, and to subsequently ignite it with a separate short-pulse high-intensity laser or particle (electron or ion) pulse. According to Inertial Fusion Science and Applications 1999, edited by C. Labaune, W. J. Hogan, and K. A. Tanaka (Elsevier, New York/Amsterdam, 1999), Fast Ignition is being studied by many groups worldwide. Achievements to-date include attaining a conversion efficiency of 10% of laser light into a proton beam and focusing the beam to better than 50 μm a spot size, as is disclosed, e.g., by Hegelich et al., Experimental demonstration of particle energy, conversion efficiency and spectral shape required for ion-based fast ignition, Nucl. Fusion 51 083011 (2011), R. SNAVELY et al. Phys. Rev. Lett. 85, 2945(2000), and M. Key et al., Fast Ignition: Physics Progress in the US Fusion Energy Program and Prospects for Achieving Ignition.

The vast majority of these approaches are based on D-T fuel and use a longer ns pulse laser system for compression of the fuel. A different option is using a pB fuel. Hora et al., Matter and Radiation at Extremes 2, 177 (2017) suggest that the barrier for igniting pB fuel can be lowered by exploiting new plasma physics. The phenomenon of “non-thermal” fusion reactions, i.e., fusion reactions that are not induced in a thermonuclear regime but make use of non-equilibrium, non-thermal distributions, were demonstrated by Belyaev, V., et al., Observation of neutronless fusion reactions in picosecond laser plasmas, Physical review. E, Statistical, nonlinear, and soft matter physics, 2005. 72: p. 026406; Labaune, C., et al., Laser-initiated primary and secondary nuclear reactions in Boron-Nitride, Scientific Reports, 2016. 6: p. 21202; D. Margarone, et. al, Generation of α-Particle Beams With a Multi-kJ, Peta-Watt Class Laser System, Frontiers in Physics, 2020; Korn, G., Margarone, D. & Picciotto, A. (2014), Boron-Proton Nuclear Fusion Enhancement Induced in Boron-doped Silicon Targets by Low-contrast Pulsed Lasers, IZEST ELI-NP Conf. Paris, 17-18 Sep. 2014; Picciotto, A., et al., Boron-Proton Nuclear-Fusion Enhancement Induced in Boron-Doped Silicon Targets by Low-Contrast Pulsed Laser, Physical Review X, 2014, 4: p. 031030; and Margarone, D., et al., Advanced scheme for high-yield laser driven nuclear reactions, Plasma Physics and Controlled Fusion, 2014, 57(1): p. 014030. These results extended from the observation that these pB reaction gains are many orders of magnitude higher. In particular, the results of Korn, Picciotto and Margarone achieved one billion times higher reaction yields.

To allow non-thermal, i.e., non-equilibrium, fusion concepts, two technologies are key: laser systems that reach a sufficiently high intensity, peak power, contrast and pulse length, and nanostructured fuel pellets (“targets”) that enable efficient laser absorption and control of non-linear optical effects. The present disclosure relates to targets that enable a novel, non-thermal ignition approach.

Targets for laser-driven inertial fusion can be of various shape and form. With the continuous innovation in nanotechnology and the ability to fine-tune ever more granular target structures, novel, nanostructured non-frozen targets can be produced. Specifically, different approaches for surface structured targets can be chosen for largely increased laser absorption.

Bargsten, Volumetric creation of ultra-high-energy-density plasma by irradiation of ordered nanowire arrays, Master Thesis at Colorado State University (2016) discloses ordered nanowire arrays (nanorods) showing beneficial properties for laser absorption and the creation of immense plasma densities. Fedeli et al, Ultra-intense laser interaction with nanostructured near-critical plasmas, Scientific Reports 8:3834 (2018); DOI: 10.1038/s41598-018-22147-6, discloses that the presence of nanorods strongly reduces the effect of pulse polarization, and enhances the energy absorbed by the ion population, while leading to a significant decrease of the electron temperature with respect to a homogeneous near-critical plasma. Physics of Plasmas 29, 013301 (2022) (https://doi.org/10.1063/5.0064364) demonstrates 80% laser absorption efficiency for a 40 fs laser pulse with 1019 W/cm² intensity and randomly and vertically oriented nanowires made of ZnO semiconductor material, a˜2x enhancement compared to flat targets. Phys. Rev. Research 3, 043181 (2021) (https://journals.aps.org/prresearch/abstract/10.1103/PhysRevResearch.3.043181) discloses that irradiation of deuterated nanowire targets at intensities of 3×10²¹ W/cm² with high contrast λ=400 nm laser pulses of 45 fs duration leads to plasma dynamics in which the tip of the nanowires rapidly explodes to form an overdense plasma, but the onset of relativistic transparency allows the ultrashort laser pulse to penetrate deep into the nanowire array, enhancing particle acceleration.

There have also been experiments with amorphous pB-based targets using PW-class laser systems. Margarone et al., Generation of α-Particle Beams With a Multi-kJ, Peta-Watt Class Laser System, Front. Phys., September 2020, (https://doi.org/10.3389/fphy.2020.00343) discloses an alpha particle flux of 10⁹ and a laser absorption efficiency of 7%.

Patent literature in the above technical field comprises US 2018/0322962 A1, US 2004/0213368 A1, U.S. Pat. No. 4,199,685 A, US 2017/0125129 A1, and US 2020/0321135 A1.

The thermonuclear approach to fusion is a quasi-equilibrium approach based on neutron rich reaction chains. They typically have the lowest activation energies or, in the terminology of equilibrium physics, require the lowest temperature for fusion to set in.

The main advantage of equilibria is that there is little net energy transfer amongst the components which are in equilibrium with each other. A disadvantage, however, is that the reactivity of equilibria is extremely small. Due to hard temporal limitations for the reacting system, the reaction rate has to be large in order to burn a sizable fraction of the fuel.

So far, it is tried to enhance the fusion rate by massive material compression, which tends to shift the main share of the costs into a viable thermal fusion concept to fusion target implosion. The latter comes along with a new yet unresolved range of problems, including Rayleigh Taylor Instabilities and laser-plasma instabilities.

Aneutronic reaction chains such as pB or others do not have to deal with the problem of energetic neutrons. However, they require very high ignition temperature under classical thermonuclear conditions. They also face the problem of massive material compression for burning a large enough amount of fuel for energy production. These problems prevent successful commercialization of fusion technology based on pB fuel as the associated laser system costs for reaching these high temperatures and high compression levels are above any reasonable amount that would allow to provide electricity at competitive prices.

Non-thermal approaches based on pB fuel, i.e., approaches that act outside of the thermonuclear regime, rely on efficient ways to generate non-thermal ion distribution functions that can sustain long enough. Non-thermal ionic distributions are therefore a prerequisite for efficient fusion with advanced fuels. Up to now non-equilibrium fusion concepts have little track record. The physics of converting laser energy into fusion products like charge particles is quite different and challenging. However, with the advent of efficient energetic ultra-short optical laser pulses and the capabilities to manufacture nanostructured targets, it is now possible to follow non-equilibrium routes into fusion.

### BRIEF SUMMARY AND INITIAL DESCRIPTION

Embodiments of the present disclosure efficiently trigger fusion reactions non-thermally, with high reactivity in a broad range of relative center of mass kinetic energies between the fusion partners and thereby obtaining an economically viable path to energy production based on aneutronic and/or neutronic fuels via efficient conversion of a driver energy in fusion products and therefore fusion energy.

According to the present disclosure, a target for non-thermal triggering a nuclear fusion reaction comprises a plurality of aligned nano-rods of a first nuclear fusion fuel material, and an interspace between the nano-rods filled with a second nuclear fusion fuel material, wherein the first and second nuclear fusion fuel materials are different from each other.

In this context “aligned nano-rods” encompasses configurations in which the nano-rods are parallel to each other, or in which for each first of the nano-rods there is a second of the nano-rods which two nano-rods lie in a common plane, i.e., can be angled with respect to each other within a flat plane.

Nuclear fuel mixes with optimized morphology allow to make use of the full momentum spectrum of the nano-accelerated fuel ions for triggering efficiently nuclear reactions. This way, it is possible to particularly efficiently trigger fusion reactions by the use of a target according to the present disclosure.

The fuel of the whole target can be completely made of fusion materials. This leads to a very efficient conversion of laser energy into ion kinetic energies with non-thermal distribution functions enabling very high fusion rates and yields. In this context, “completely made of fusion materials” also means configurations including contaminations of the fusion material, cavities in the material or other imperfections, e.g., from the manufacturing of the target or its constituents. At least, the fuel of the whole target can be predominantly made of fusion material.

The target of the present disclosure can be irradiated with multiple ultra-short ultra-intense laser pulses that can be interlaced. This mitigates the need for single extremely energetic laser pulses and enables the usage of scalable laser technology.

The target of the present disclosure acts as a nano-structured accelerator, when powered by a short pulse high intensity laser. For reasons of efficiency, it preferably consists of nuclear fusion fuel material, but it is also possible to make use of fuel mixes with different fuel masses, fuel densities, and fusion resonances. The target can be designed such that high laser energy conversion efficiency into collective electromagnetic fields and into the relative energies in the fuel subsystem is achieved. Laser-driven propagating Coulomb explosions can be tailored to the underlying nuclear fuel mix.

In more detail, the laser ionizes the nano-rods to a certain degree within femtoseconds leaving net positive charges behind. The latter Coulomb explode leading to non-thermal ionic distributions of the nuclear fusion fuel materials.

This way, the target is an efficient design for the generation of large high energy ionic currents with non-thermal distribution functions. It can be powered by ultra-short ultra-intense laser pulses in the optical to the vacuum ultraviolet (VUV) wavelength range. The target can be tailored such that it absorbs the driver laser energy almost completely.

When an intense ultra-short laser pulse interacts with the target, it extracts a fraction of the fuel electrons of the first nuclear fusion fuel material on ultra-short time scales and over-heats them. Over-heated electrons are those that cannot return into the nano-rods immediately. Hence, positive ions are exposed to their own electric space-charge field and Coulomb explode, leaving behind, after some time, a nearly homogeneous ionic distribution in configuration space and a non-thermal one in the momentum space that is peaked at the resonances of the provided nuclear fuel mix.

The laser ionizes the nano-rods at least partially and the electrons occupy the space inside and between the nano-rods in such a way that individual nano-rods are partially shielded from each other and still provide an ion accelerating electric field strong enough to obtain the relative energies between the nuclear fusion fuel material constituents required for fusion resonances of the fuel mix.

Decisive for the use of fusion energy is the ratio of the total energy required for the fuel ions and of the total energy released from nuclear fusion.

As a preferred example of the present disclosure, it is conceivable to accelerate deuterons in deuterated boron nano-rods and immerse tritium in-between the deuterated boron rods or to consider any other spatio-temporal configuration and fuel mix.

In order to utilize the faster protons or deuterons obtained from the Coulomb explosions, lithium can be considered. At the same time, the non-linear optical properties of the target can be used to make sure that nano-acceleration is optimized to the fuel mix and its spatio-temporal configuration. In this context, it is possible, for example, to combine short pulse UV and VUV driver frequencies at high power levels with an appropriate target that only consist of tailored nuclear fusion fuel materials taking actively part in the fusion reaction chains. Again, in this context, “only consisting of tailored nuclear fusion fuel materials” also means configurations including contaminations of the fusion material, cavities in the material or other imperfections, e.g., from the manufacturing of the target or its constituents. At least, the preferred target predominantly consists of tailored nuclear fusion fuel materials taking actively part in the fusion reaction chains.

To optimize energy conversion efficiency of the target, the size and shape of the nano-rods and the nuclear fusion fuel materials of the target can be modified.

Essentially, aneutronic fusion reactions, such as p+B¹¹→3α+8.9 MeV, i.e., pB fusion in nanostructured materials can be triggered, respectively, by short ultra-intense optical laser radiation extending to the UV and VUV spectral range. The nanostructured material is supposed to work as an ultra-fast and efficient absorber for the laser, while efficiently accelerating the ions and enhance the fusion reactivity also for lower center of mass kinetic energies of fusion partners due to massive collective screening effects.

Laser deposition in these materials is very efficient and electrons tend to over-heat. For example, nanostructured protonized boron composite materials can absorb ultra-short optical laser pulses almost entirely, which leads to electrons being rapidly expelled from the nano-structures and to consecutive Coulomb explosion. This generates a non-thermal, i.e., non-equilibrium, distribution for fusion-relevant ions within femtoseconds that are sufficient for pB fusion but also lead to ion energies favorable for ignition of the other parts of the fuel mixes like DT which have a much lower center of mass kinetic energy requirement for efficient fusion.

Since the laser induced relative velocities between, for example, protons and boron ions are large, the reactivity is large, which in turn allows for lower average densities in the system allowing to work with targets near solid state densities. Since laser-deposition and fusion in the nanostructured absorber are fast, instabilities are avoided. Hence, there is reduced experimental complexity that is more easily manageable, and significantly less laser energy is required for converting the laser energy into fusion products, making the total system cost economically viable as a converter and/or ignitor.

One underlying physical model is in essential parts of quantum nature. Due to large electric and magnetic fields induced by the absorbed short pulse laser energy in the nanostructured material of the target, the Coulomb barriers for fusion processes are shielded. Consequently, the effective tunnelling length for protons through the shielded Coulomb barrier is increased. This leads to fusion cross sections in the system which are enhanced by orders of magnitude even at smaller center-of-mass kinetic energies between the fusing ionic components. Since the shielded cross sections in the absorber are enhanced, fusion takes place over a much larger center of mass kinetic energy range including smaller energies therefore enhancing fusion reactivities, gain and fusion energy output and covering a broad energy range where different fuel mixes will have resonances in their fusion cross sections. This allows to use different materials including neutronic as well as aneutronic fuels.

In addition, the nanostructured material of the target has an interesting scaling behavior with the wavelength of the laser pulse. For shorter wavelengths of the driver pulse the concept proposed here continues to improve. For instance, working at half the laser wavelength means that four times the critical plasma density in the nanostructured material will be reached, leading to sixteen times the fusion yield within the same time window. Shortening the wavelength to UV or VUV allows therefore for highly efficient conversion of laser energy into fusion products at near solid density and therefore can lead to ignition (break-even) and gain.

The present concept is based on high peak-power laser pulses with high contrast and intensity, wherein the laser pulses preferably are femtosecond optical laser pulses.

The nanostructured target enables fast and highly efficient optical laser absorption (>90%) without parametric instabilities. The absorption is hence significantly higher than the typical absorption efficiency seen in other ns laser-based ignition approaches.

The nanostructured target irradiated with high intensity short laser pulses leads to non-thermal distribution functions due to efficient Coulomb explosions for fusion relevant materials that involve all ions and, consequently, to very large reactivities.

Since reactivities in the proposed concept are large, lower average densities are permissible. Therefore, an optical laser pulse can propagate through the nanostructured material at almost speed of light, which implies that the pulse never interacts with corrupted nanostructured material. Hence, the laser pulse can generate non-thermal distributions of fusion relevant ions until it is almost depleted.

The target can be tailored to the laser pulse allowing to control the shape of the distribution functions that are created.

Irradiating of the nanostructured material of the target by a laser pulse can lead to rapid evacuation and over-heating of electrons. Strong collective fields can be formed by the expelled overheated electrons. These fields can lead to significant screening of the Coulomb barriers that immensely increase the fusion rates for pB at lower center of mass kinetic energies to several barns, even above thermonuclear fusion rates for DT.

An advantage of the concept is that this process can be controlled through the variation of different technical parameters:

Firstly, the relative velocity (i.e., center-of-mass kinetic energy) between protons and/or deuterons and boron ions can be controlled through the design of the nanostructured material and the laser pulse.

Secondly, shorter wavelengths for the laser pulse results in a massive improvement for fusion yield. Operating for instance at half the wavelength means sixteen-fold the fusion yield in the same time window.

Thirdly, the average density of the nanostructured material and the wavelength of the laser pulse can be optimized to maximize fusion power and fusion yield.

The present concept can work as a converter or ignitor for a subsequent burn to reach high energy gain factors by operating the target at shorter yet still optical wavelengths of the laser pulse leading to significant enhancement of fusion power and yield.

The method based on ultrafast high intensity laser deposition described in the present disclosure is significantly faster, i.e., 10 ths of fs, than traditional laser fusion approaches, thus avoiding instabilities. Further, this concept works in a broader range of center-of-mass energies and significantly less laser energy can be applied to achieve ignition, which may be decisive for using fusion energy in commercial electric power generation.

The nano-rods can be filled solid nano-rods or they can be hollow nano-rods.

Preferably, a portion or all of the nano-rods of the target are cylindrically or conically shaped while having a circular, elliptical, rectangular, or polygonal base each having a rod-diameter (A) and a rod-length (C). Further preferably, the rod-diameter (A) is 100 nm or smaller, even further preferably 50 nm or smaller, and most preferably 30 nm or smaller. In case of conical nano-rods, the rod diameter means the largest rod diameter of a particular rod, i.e., usually at its bottom or top, depending on its orientation. Similarly, it is further preferred that the rod-length (C) is above 10 μm, further preferably between 10 μm and 100 μm, most preferably between 10 μm and 300 μm.

The rod-length is, in this context, the height of the cylindrical rod, i.e., the perpendicular distance between its top base and the common base.

Following the above, the nano-rods have a thickness which is smaller than in, e.g., Phys. Rev. Research 3, 043181 (2021) to support Coulomb explosions. This leads to a very efficient conversion of laser energy into ion kinetic energies with non-thermal distribution functions enabling very high fusion rates and yields.

Advantageously, the nano-rods of the target are regularly arranged along one first direction, which is a linear direction or a circular direction, so that adjacent nano-rods are spaced along the first direction by a first rod-distance. For the nano-rods to be regularly arranged along a direction, the first rod-distance is substantially the same or an integer multiple for a plurality of nano-rods of the target, preferably for at least 50% of the nano-rods of the target, most preferably for at least 90% of the nano-rods of the target along that direction. Alternatively, for the nano-rods to be regularly arranged along a direction, the first rod-distance varies in accordance with an expected variation of irradiation intensity of a laser pulse to be absorbed by the target.

In the present context, a rod-distance is defined as the lateral distance between the lateral centers of two rods.

Further advantageously, the nano-rods of the target are regularly arranged along two perpendicular directions so that adjacent nano-rods are spaced along a first direction of the two perpendicular directions by a first rod-distance and along a second direction of the two perpendicular directions by a second rod-distance. For the nano-rods to be regularly arranged along a direction, the first and second rod-distances are substantially the same or an integer multiple for a plurality of nano-rods of the target, preferably for at least 50% of the nano-rods of the target, most preferably for at least 90% of the nano-rods of the target along that direction. Alternatively, for the nano-rods to be regularly arranged along a direction, the first and/or second rod-distance vary in accordance with an expected variation of irradiation intensity of a laser pulse to be absorbed by the target. Nanostructures, fuel type, and laser parameters can be tailored for optimal performance. However, the first rod-distance along the first direction can be different from the second rod-distance along the second direction. The first and second directions can be arranged perpendicularly in a Cartesian coordinate system, but also in a circular coordinate system or other coordinate systems.

Using cylindrical rods facilitates using technical parameters to optimize fusion yield. Such technical parameters are the density of the material, the rod-diameter, the rod-length, and the distances between adjacent rods. This is advantageous over the prior art based on, for example, amorphous non-structured targets.

The absorbing target works at a range of parameters. However, to maximize fusion yield, it is preferred that the target and laser properties are aligned. According to the fundamental scaling behavior of the target, fusion yield significantly increases with shorter wavelength. Hence, preferably, the first rod-distance, and further preferably also the second rod-distance, as the case may be, is greater than or equals \sqrt{R²nᵢe²/4π∈₀mₑω²}, wherein R is the radius of the rod, nᵢ is the average ion density, e is the charge of an electron, ε₀ is the electric field constant, mₑ is the electron mass, and ω is the laser carrier frequency.

In other words, the rod-distance is proportional to 1/ω, i.e., the laser carrier frequency. Hence, if ω is doubled, the distance between adjacent nano-rods in two perpendicular directions is halved, the density of nano-rods per area is four times as large which means that four times as many nano-rods with the same electron release capability can be admitted in the target. This means that the fusion power is then about 16-times as large, while the amount of fusion material is four-fold as high. In summary, decreasing the wavelength by a factor x increases the fusion yield by a factor of x⁴.

As to the rod-diameter, the intensity of the laser, including its focal spot, and optionally the second nuclear fusion fuel material filling the interspace between the nano-rods, is preferably taken into consideration when determining the rod-diameter of the nano-rods.

The rod-length is preferably determined by how far the laser can propagate into the target until it has fully depleted its energy.

In a preferred embodiment, the nuclei of the first nuclear fusion fuel material have a first atomic number and the nuclei of the second nuclear fusion fuel material have a second atomic number, wherein the first atomic number is higher than the second atomic number.

For reasons of efficiency in the mixed fuel context the nano-rods should consist of a larger Z fuel-based substrate into which lower Z fuel-based constituents are embedded with an appropriate ratio. Here Z is the atomic number of a nucleus. Such an example is the p¹¹B fuel cycles mixed with DT, which we suggest for a preferred target according to the present disclosure. The different Z numbers in the mix open up a laser driver frequency window for non-thermal DT operation via the embedded boron nano-rods. To drive DT via the integrated boron nano-rods ultra-intense ultra-short optical to UV and VUV laser driver frequencies are required. Then the gap in the Z numbers of a nuclear fuel mix consisting of p¹¹B and DT as proposed here allows non-thermal DT operation even though DT cannot form an efficient nano-structured target by itself. As an alternative to solid nano-rods of, for example, boron, hollow cylinders are also envisaged.

Preferably, the first nuclear fusion fuel material comprises boron and/or lithium, in particular enabling p¹¹B, p⁶Li and/or D⁶Li fusion reactions to occur. Also preferably, the second nuclear fusion fuel material comprises tritium and/or deuterium, for triggering DT reactions.

In a preferred embodiment, the first nuclear fusion fuel material is doped with a further nuclear fusion constituent. In particular, boron can be doped with p, D and/or Li can be doped with p.

Optionally, the plurality comprises nano-rods of different first nuclear fusion fuel materials, in particular of B and Li, which are interlaced.

A system for producing neutronic and aneutronic fusion energy by a neutronic and/or aneutronic nuclear fusion reaction according to the present disclosure comprises a target as described above, and a laser device for emitting a laser pulse, wherein the laser pulse can at least partially be absorbed by the target. Preferably, the laser pulse is a femtosecond optical to VUV laser pulse.

A method for producing neutronic and aneutronic fusion energy by a neutronic and/or aneutronic nuclear fusion reaction according to the present disclosure comprises irradiating a target as described above with a laser pulse, wherein the laser pulse is at least partially absorbed by the target. Again, it is preferred that the laser pulse is a femtosecond optical to VUV laser pulse.

In the system and method, respectively, the laser pulse and the target are adapted to each other. For example, the target is tailored to an available laser pulse in its shape and choice of material, for example as explained above with respect to the rod-distances between adjacent rods.

The proposed target can be operated with pure nuclear fusion fuel materials and with nuclear fusion fuel material mixes. For example, it is possible to make use of neutronic fuels like DT and aneutronic fuels like p¹¹B, p⁶Li, and D⁷Li.

The proposed target generates non-thermal ionic distributions. The integrated nano-rods of the target can be made of, for example, boron or lithium. Both, boron and lithium are possible nuclear fusion fuel materials. This enhances efficiency since the heating of non-fusion relevant materials is avoided. A range of nano-morphologies are possible in order to tailor the target towards an optimal nuclear fusion fuel mix.

It is possible to dope the nano-rods, for example based on boron or lithium, with further nuclear fusion fuel materials. For example, D, p, or lithium can be implanted into boron or vice versa p can be implanted into lithium while the gaps between the nano-rods can be filled in with a broad range of second nuclear fusion fuel materials. It is possible to take advantage of chemical boron compounds that already contain protons. Moreover, it is possible to interlace boron and lithium-based nano-rods inside the target.

With ultra-short ultra-intense laser pulses, the target allows efficient non-thermal reactor operation at near solid fuel densities for a range of fuel compositions due to much enhanced reactivities.

Nuclear fuel mixes with optimized morphology allow to use the full momentum spectrum of the fuel ions for efficiently triggering nuclear reactions.

The rod diameters of the nano-rods of the target are between approximately 20-100 nm. In case of conical nano-rods, the rod diameter means the largest rod diameter of a particular rod, i.e., usually at its bottom or top, depending on its orientation. They are much smaller than those discussed in the literature at present. As a consequence, efficiently propagating Coulomb explosion in the mixed fuel context are triggered due to the morphology of the integrated nano-rods leading to non-thermal ion distribution functions covering a very broad range of resonances of fusion cross section for different fuel mixes.

Further advantages and additional features of the disclosure become apparent from the set of claims and the following detailed description.

### BRIEF DESCRIPTION OF THE DRAWINGS

FIG. 1 illustrates a perspective view of a preferred target.

FIGS. 2a and 2b illustrate a top view of the preferred target of FIG. 1.

FIG. 3 illustrates a side view of the preferred target of FIG. 1.

FIG. 4 shows the conversion fraction η^{pB} as a function of β^{pB} and n_{B}Rₚ.

FIG. 5 is an exemplary isocontour plot illustrating the scaling behavior of the conversion efficiency Q^{pB}.

FIG. 6 shows the conversion fraction η^{DT} as a function of β^{DT} and n_{T}R_{D}.

FIG. 7 is an exemplary isocontour plot illustrating the scaling behavior of the conversion efficiency Q^{DT.}

### DETAILED DESCRIPTION

In the following detailed description, same or corresponding elements and features are referenced by the same or corresponding reference signs and a repetitive description thereof is avoided.

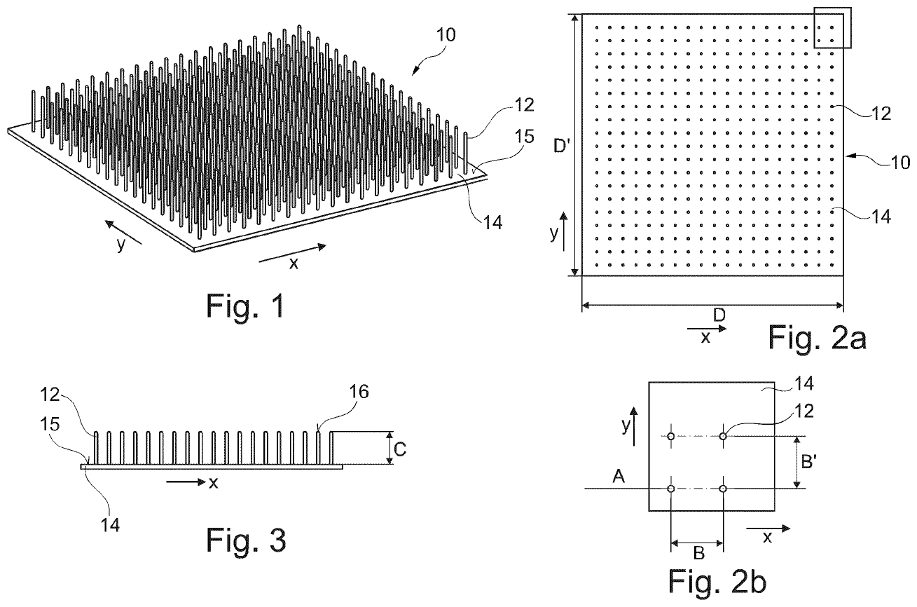

FIG. 1 illustrates a perspective view of a preferred target 10. A common base 14 is, in the illustrated embodiment, square shaped and has a flat upper surface 15 from which a plurality of nano-rods 12 extend perpendicularly from the common base 14. The nano-rods 12 are regularly arranged along a first direction X and a second direction Y, wherein the first direction X and the second direction Y are perpendicularly oriented with respect to each other in a Cartesian sense. Alternative arrangements of perpendicular directions are, for example, according to circular coordinates, i.e., along a radius with respect to an origin, and a circumference about this origin.

FIGS. 2a and 2b illustrate a top view of the preferred target 10 of FIG. 1, wherein FIG. 2a illustrates a total top view of the target 10, and FIG. 2b a detailed view of the illustration of FIG. 2a, namely, the top right corner including four of the nano-rods 12 illustrated in FIG. 2a. The top view of FIG. 2a more clearly illustrates that the nano-rods 12 are regularly, in this embodiment periodically, arranged along the first and second directions X and Y. FIG. 2a also illustrates a first target side length D and a second target side length D′. As illustrated, it is preferred that the nano-rods 12 are regularly arranged over the total of the first and second target side lengths D and D′. FIG. 2b highlights that a first rod-distance B between adjacent nano-rods in the first direction X is equal to a second rod-distance B′ between adjacent nano-rods in the second direction Y. Although the first and second rod-distances B, B′ can differ from each other, it is preferred that the first rod-distance B is the same as the second rod-distance B′ for at least 50% of the nano-rods 12 of the target 10, further preferably for at least 90% of the nano-rods 12 of the target 10. A rod-diameter A is smaller than the first and second rod-distances B, B′.

FIG. 3 illustrates a side view of the preferred target 10 of FIG. 1. In this side view according to FIG. 3, the nano-rods 12 are shown to have a rod-length C which is measured perpendicularly to the surface 15 of the common base 14 and between the surface 15 and a top base 16 of the nano-rods 12. The nano-rods 12 illustrated here are straight cylinders but can also be non-cylindrically shaped or oblique cylinders or hollow cylinders. However, the illustrated shape of the nano-rods is preferred.

The first and second target side lengths D and D′ of the target 10 can preferably be determined by a size of a focal spot of the laser used for the ignition, and the necessary amount of material around it to get gain well above one. As the nano-structured material has areal scaling properties, increasing D and D′ and the focal spot of the laser also increases the total fusion yield. Another parameter for variation is the composition of the target material as described before.

A system for ignition of a non-thermal fusion reaction also comprises a laser device, which is not illustrated, and which is configured for emitting a laser pulse, wherein the laser pulse has a laser carrier frequency ω, a pulse duration, and a spot size, and which can at least partially be absorbed by the nano-structured material of the target 10. An intensity of the laser pulses measured in W/cm² can be varied through increasing the pulse energy, the pulse length or the focus spot size of the laser device. Further, the wavelength of the laser pulse can be varied.

It is preferred that the target 10 and laser properties are aligned. According to the fundamental scaling behavior of the target 10, fusion yield significantly increases with shorter wavelength. Hence, preferably, the first rod-distance B and the second rod-distance B′ of the target 10 is greater than or equals \sqrt{R²nᵢe²/4π∈₀mₑω²}, wherein R is the radius of the rod, nᵢ is the average ion density, e is the charge of an electron, so is the electric field constant, mₑ is the electron mass, and ω is the laser carrier frequency.

The intensity of the laser, including its focal spot, then determines the optimum diameter of the nano-rods. The rod length is determined by how far the laser can propagate into the target until it has fully depleted its energy. In the following, Examples of preferred technical parameters for the system of the laser device and target 10 are shown:

### Example 1

Laser system:

| | | |
|---|---|---|
| Wavelength | 210 | nm |
| Intensity | 10²¹ | W/cm² |

Nano-rods 12 of target 10:

| | | |
|---|---|---|
| Rod-diameter A | 30 | nm |
| Rod-length C | 10-300 | μm |

| | |
|---|---|
| First rod-distance B | 200 nm (center to center) |
| Second rod-distance B′ | 200 nm (center to center) |

### Example 2

Laser system:

| | | |
|---|---|---|
| Wavelength | 400 | nm |
| Intensity | 10²¹ | W/cm² |

Nano-rods 12 of target 10:

| | | |
|---|---|---|
| Rod-diameter A | 30 | nm |
| Rod-length C | 10-300 | μm |

| | |
|---|---|
| First rod-distance B | 400 nm (center to center) |
| Second rod-distance B′ | 400 nm (center to center) |

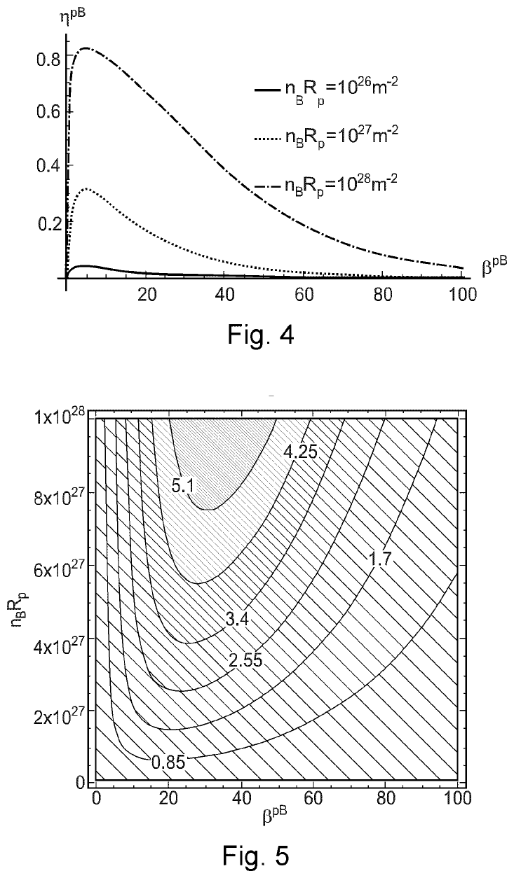

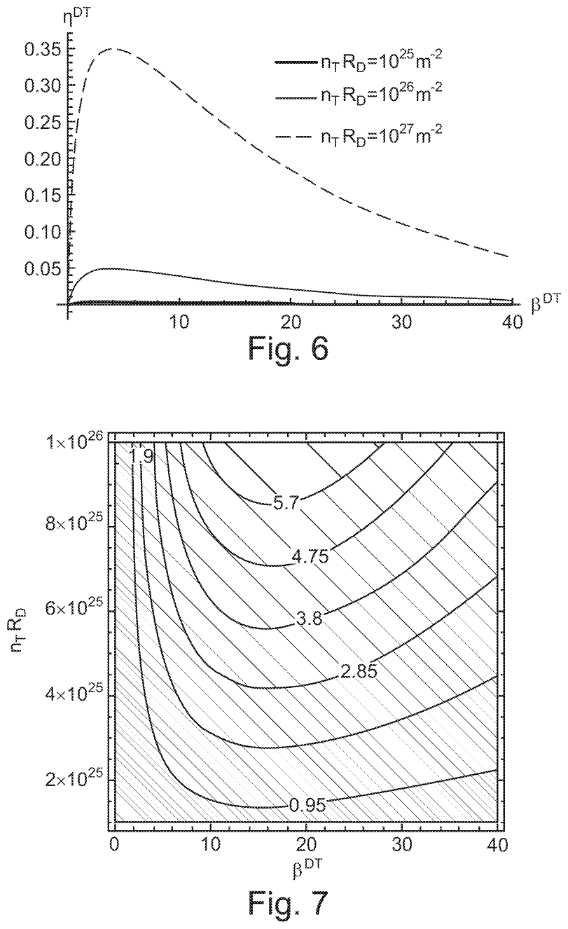

FIGS. 4 and 6 are exemplary graphs illustrating conversion fractions. FIG. 4 illustrates the conversion fraction η^{pB} as a function of β^{pB} and n_{B}Rₚ. FIG. 6 illustrates the conversion fraction η^{DT} as a function of β^{DT} and n_{T}R_{D}.

FIGS. 5 and 7 are exemplary isocontour plots illustrating Q of the fusion energy yield and in particular the scaling behavior of Q normalized to the initial energy in the ionic distributions after laser energy deposition of preferred non-thermal pB and DT fusion reactions as a function of β^{pB} and β^{DT} as well as n_{B}Rₚ and n_{T}R_{D}, respectively.

FIG. 5 illustrates the effective Q^{pB} as a function of β^{pB} and n_{B}Rₚ. With increasing n_{B}Rₚ the parameter β^{pB} has to grow for best Q^{pB}. Large β^{pB}, however, imply a smaller conversion fraction η^{pB}.

The conversion efficiency Q^{DT} as a function of β^{DT} and n_{T}R_{D} is shown in FIG. 7. With increasing n_{T}R_{D} the parameter β^{DT} has to grow for best Q^{DT}. Large β^{DT} however, imply smaller η^{DT}.

### LIST OF REFERENCE SIGNS

10 target
12 nano-rod
14 common base
15 surface
16 top base
A rod-diameter
B first rod-distance
B′ second rod-distance
C rod-length
D first target side length
D′ second target side length
X first direction
Y second direction

The various embodiments described above can be combined to provide further embodiments. All of the U.S. patents, U.S. patent application publications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A target for triggering nuclear fusion reactions non-thermally, the target comprising:
a plurality of aligned nano-rods of a first nuclear fusion fuel material, and
an interspace between the nano-rods filled with a second nuclear fusion fuel material,
wherein the first and second nuclear fusion fuel materials are different from each other.

2. The target according to claim 1, wherein a portion or all of the nano-rods of the target are cylindrically or conically shaped while having a circular, elliptical, rectangular, or polygonal base, each having a rod-diameter and a rod-length.

3. The target according to claim 1, wherein nuclei of the first nuclear fusion fuel material have a first atomic number and nuclei of the second nuclear fusion fuel material have a second atomic number, wherein the first atomic number is higher than the second atomic number.

4. The target according to claim 1, wherein the first nuclear fusion fuel material comprises boron and/or lithium.

5. The target according to claim 1, wherein the second nuclear fusion fuel material comprises tritium and/or deuterium.

6. The target according to claim 1, wherein the first nuclear fusion fuel material is doped with a further nuclear fusion constituent.

7. The target according to claim 1, wherein the plurality of aligned nano-rods comprises nano-rods of different first nuclear fusion fuel materials which are interlaced.

8. A system for producing neutronic and aneutronic fusion energy by a neutronic and/or aneutronic nuclear fusion reaction, the system comprising:
a target according to claim 1, and
a laser device for emitting a laser pulse, wherein the laser pulse can at least partially be absorbed by the target.

9. The system according to claim 8, wherein the laser pulse is a femtosecond optical to vacuum ultraviolet (VUV) laser pulse.

10. A method for producing neutronic and aneutronic fusion energy by a neutronic and/or aneutronic nuclear fusion reaction, the method comprising irradiating a target according to claim 1 with a laser pulse,
wherein the laser pulse is at least partially absorbed by the target.

11. The method according to claim 10, wherein the laser pulse is a femtosecond optical to vacuum ultraviolet (VUV) laser pulse.

12. The target according to claim 2, wherein the rod-diameter is 100 nm or smaller.

13. The method according to claim 12, wherein the rod-diameter is 50 nm or smaller.

14. The method according to claim 12, wherein the rod-diameter is 30 nm or smaller.

15. The method according to claim 2, wherein the rod-length is above 10 μm.

16. The method according to claim 15, wherein the rod-length is between 10 μm and 100 μm.

17. The method according to claim 15, wherein the rod-length is between 10 and 300 μm.

18. The target according to claim 4, wherein the first nuclear fusion fuel material comprises p¹¹B, p⁶Li, ²D⁶Li, n⁶Li, and/or n⁷Li reactions.

19. The target according to claim 6, wherein the boron is doped with p, D and/or Li, and the Li is doped with p.

20. The target according to claim 7, wherein the plurality of aligned nano-rods comprises nano-rods of B and Li which are interlaced.
